(19) United States
(12) Patent Application Publication
(10) Pub. No.: US 2010/0304197 A1
(43) Pub. Date: Dec. 2, 2010

(54) Flexible foil prismatic battery having improved volumetric efficiency

(76) Inventors: Ramesh C. Bhardwaj, Fremont, CA (US); Louie J. Finkle, Long Beach, CA (US)

Correspondence Address: Morland C. Fischer, Suite 1300, 2030 Main Street, Irvine, CA, 92614, US

(21) Appl. No.: 12/455,400

(22) Filed: Jun. 2, 2009

(51) Int. Cl. H01M 6/10; H01M 6/42

(52) U.S. Cl. 429/94; 429/156; 429/159

(57) ABSTRACT

A (e.g., 12-volt) lead acid battery having prismatic and wound prismatic battery cells that are arranged relative to one another within a standard battery casing to avoid wasted space whereby to improve the overall volumetric efficiency of the battery relative to conventional batteries having thick grids or cylindrical cell configurations. According to a first preferred embodiment, each battery cell includes a plurality of cathode and anode electrode plates, wherein each plate is manufactured from an electrically-conductive flexible foil covered on opposite sides thereof by one of a positively or negatively charged material. According to a second preferred embodiment, each battery cell includes flexible, electrically-conductive cathode and anode electrodes that are prismatically wound in an oval (i.e., flat) configuration, such that the battery cell is longer along the major axis thereof than along the minor axis. The batteries of this invention are capable of increasing their stored energy capability and maximizing their power performance by avoiding unused or wasted volume within the battery casing so as to improve the stored energy capacity and cold-cranking power.

### BACKGROUND OF THE INVENTION

1. Field of the Invention

This invention relates to a (e.g., 12-volt) flexible foil lead-acid battery having prismatic and wound prismatic battery cells that are configured to avoid cumulative wasted space within the battery casing so as to improve the overall volumetric efficiency of the battery relative to batteries having thick grids or cylindrical cell configurations. By virtue of the battery cell configurations herein disclosed, the battery will be capable of increasing its stored energy capability and maximizing its power performance especially under heavy current drain conditions.

2. Background Art

Under certain extreme starting conditions (e.g., very cold weather or heavy current drains), the well-known 12-volt lead acid batteries are known to discharge rapidly because of its high impedance. Due to heavy power requirements of most cranking applications, the conventional lead acid batteries have been overbuilt which wastes power and results in the inefficient delivery of power. Consequently, after self-discharge and repeated use, the battery capacity is reduced to a fraction of its intended original capacity. In some cases, the battery may discharge after continuous use so as to be essentially ineffective in heavy current drain (e.g., automotive engine starting) applications. This behavior of a conventional lead acid battery often results in motor vehicle passengers being stranded in a cold environment.

To overcome the foregoing problem, the power of 12-volt lead acid batteries has been increased by increasing the surface contact area between the current collector electrodes and the active material of the battery. Thus, the internal resistance of the battery has been reduced which correspondingly improves efficiency and starting power of the battery, particularly under heavy current drain conditions. Such increased power batteries are known which include 2-volt battery cell units having alternating positive and negative electrode plates that are insulated from one another and tightly wound up in a spiral to create a generally cylindrical battery cell unit. However, when six 2-volt cylindrical battery cell units are arranged side-by-side one another within a battery casing, voids or interstitial spaces are created between the successive cells. The cumulative number of voids between the cylindrical cells results in unused or wasted volume within the battery casing which reduces the volumetric efficiency and correspondingly limits the stored energy capacity and cold-cranking power of the battery.

Accordingly, it would be desirable to improve the efficiency and starting ability of a (e.g., 12-volt) lead acid battery by improving the configuration of each battery cell unit such that the voids or unused interstitial spaces between successive cells is eliminated or significantly reduced and the contact area between the current collectors and the active material is maximized.

### SUMMARY OF THE INVENTION

In general terms, prismatic lead acid batteries are disclosed wherein the volumetric efficiency of the battery cells within the casing is improved relative to conventional batteries. In particular, the prismatic batteries include a flat battery cell configuration as opposed to a cylindrical cell configuration or stack grid configuration that are characteristic of certain conventional lead acid batteries. By virtue of its flat configuration, the current collecting/active material contact area of each cell is maximized while the internal resistance is reduced in order to enhance the power capacity of the cell. Moreover, the battery cells can be arranged in a close, side-by-side prismatic formation and connected in electrical series to create a 12-volt battery so that air gaps and wasted space (common to batteries having a cylindrical cell or a stack grid type configuration) between successive battery cells are eliminated, whereby substantially the entire volume within the battery casing is consumed by current-collecting electrodes and active material. As a result of its increased volumetric efficiency and low impedance, the prismatic batteries of this invention are characterized by both improved high power performance and cold cranking capacity.

According to a first preferred embodiment, each cell of the (e.g., six cell) prismatic battery includes sets of alternating current carrying cathode and anode electrode plates having a flexible metal foil substrate. The flexible foil substrates of the cathode electrode plates are covered by a negatively-charged active material, and the flexible foil substrates of the anode electrode plates are covered by a positively-charged active material. An insulating spacer separates each adjacent pair of cathode and anode electrode plates. By virtue of its prismatic configuration, the electrodes of each cell are flat plates that are packed in close face-to-face alignment with one another. A stack of flat alternating cathode and anode electrode plates which fills one cell volume within the battery casing is connected in electrical series with closely-packed stacks of flat electrode plates from adjacent battery cells by means of cast-in-place interconnects which bridge successive pairs of the cells.

According to a second preferred embodiment, each cell of the (e.g., six cell) prismatic battery includes a pair of current-carrying cathode and anode metal foil electrode plates that are wound prismatically around a solid oval core such that the cell has an oval configuration with generally flat opposite sides to facilitate an efficient side-by-side packing with adjacent oval cells. The cathode and anode plate electrode windings around the oval core alternate so as to lie one inside the other. An insulating spacer is located between and isolates the cathode electrode windings from the anode electrode windings of the oval cell. An insulating barrier separates one oval cell from the next. Each oval cell is connected in electrical series with adjacent cells by means of cast-in-place interconnects which bridge successive pairs of the battery cells.

### BRIEF DESCRIPTION OF THE DRAWINGS

FIG. 1 is illustrative of a casing for a lead-acid prismatic battery having improved volumetric efficiency according to a first preferred embodiment of this invention;

FIG. 2 is a cross-section of the battery casing of FIG. 1 showing six flat battery cells positioned side-by-side one another and connected in electrical series;

FIG. 3 is a cross-section showing the alignment of cathode and anode plate electrodes from one battery cell taken along lines 3-3 of FIG. 2;

FIG. 4 is an enlarged detail taken from FIG. 5 showing the alignment of cathode and anode plate electrodes with insulating spacers located therebetween;

FIG. 5 illustrates details of the electrical series connection of three successive battery cells shown in FIG. 2;

FIG. 6 shows the partially broken-away casing for a prismatic battery with improved volumetric efficiency according to a second preferred embodiment of this invention;

FIG. 7 is illustrative of an oval battery cell configuration common to each of the battery cells in the prismatic battery of FIG. 6; and

FIG. 8 is a top view of the oval battery cell of FIG. 7 showing cathode and anode plate electrodes prismatically wound relative to one another around an oval core.

### DESCRIPTION OF THE PREFERRED EMBODIMENT

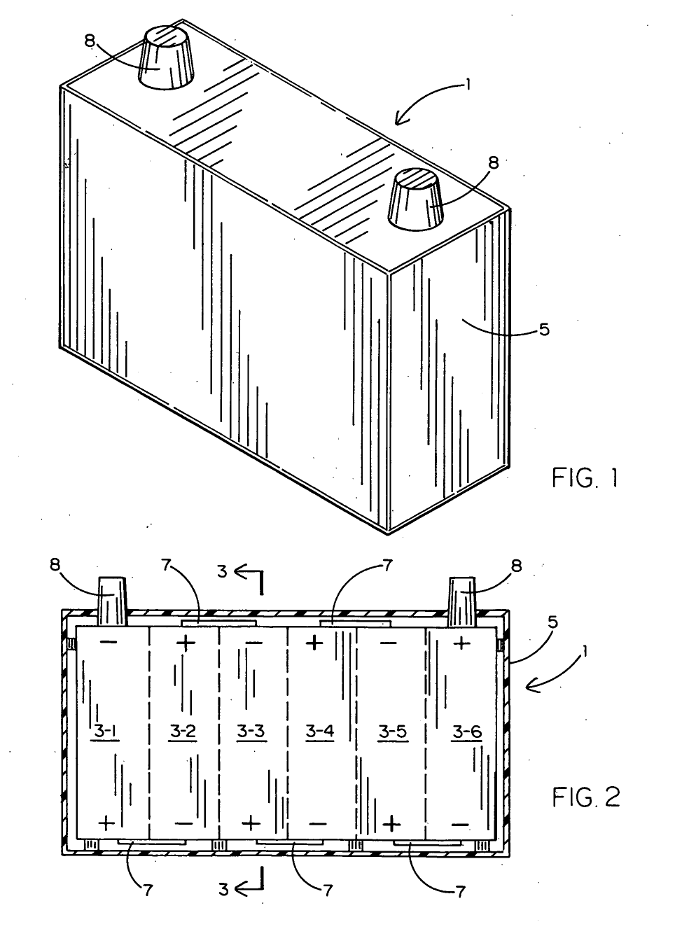

Referring initially to FIGS. 1 and 2 of the drawings, there is shown a lead acid prismatic battery 1 having increased volumetric efficiency relative to conventional metal film batteries. By virtue of the foregoing, the prismatic battery 1 will be particularly useful for high-load, high-current discharge applications such as, for example, reliably starting an engine from a motor vehicle. The battery 1 includes a total of six battery cells 3-1 . . . 3-6 (best shown in FIG. 2) surrounded by a standard battery casing 5. Each battery cell ideally generates 2 volts of electricity. Therefore, the battery 1 will be capable of generating a total of 12 volts when all six of the battery cells 3-1 . . . 3-6 are connected in electrical series, as shown. To this end, the cells 3-1 . . . 3-6 are arranged in casing 5 such that the polarity of the cells alternate from one cell to the next. That is to say, the positive terminal of the first cell 3-1 is electrically connected to the negative terminal of the second cell 3-2, the positive terminal of the second cell 3-2 is electrically connected to the negative terminal of the third cell 3-3, the positive terminal of the third cell 3-3 is electrically connected to the negative terminal of the fourth cell 3-4, and so on.

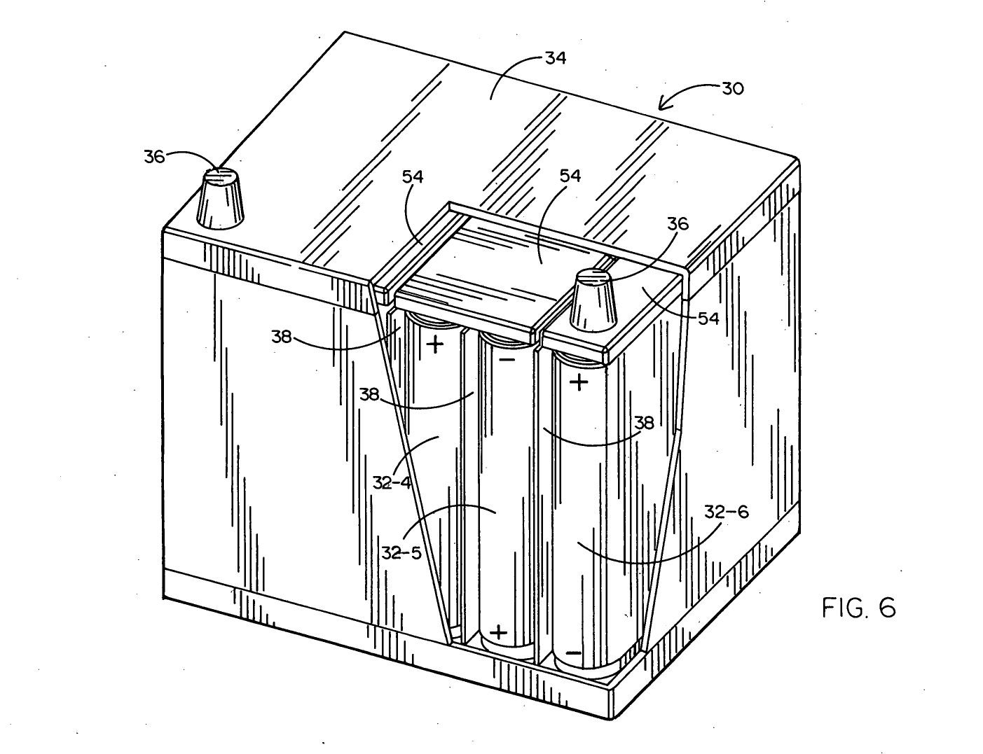

Cast-on interconnects 7 act as electrical bridges to connect electrodes from one of the battery cells 3-1 . . . 3-6 having a first polarity to electrodes from an adjacent battery cell having an opposite polarity to complete the series connection of the battery cells (best shown in FIG. 5). By way of example, the interconnects 7 may be cast-in-place from molten lead so as to bridge adjacent ones of the battery cells 3-1 . . . 3-6. A pair of generally-cylindrical terminal posts 8 project upwardly through the battery casing from the negative terminal of the first battery cell 3-1 and the positive terminal of the last battery cell 3-6 (best shown in FIG. 2).

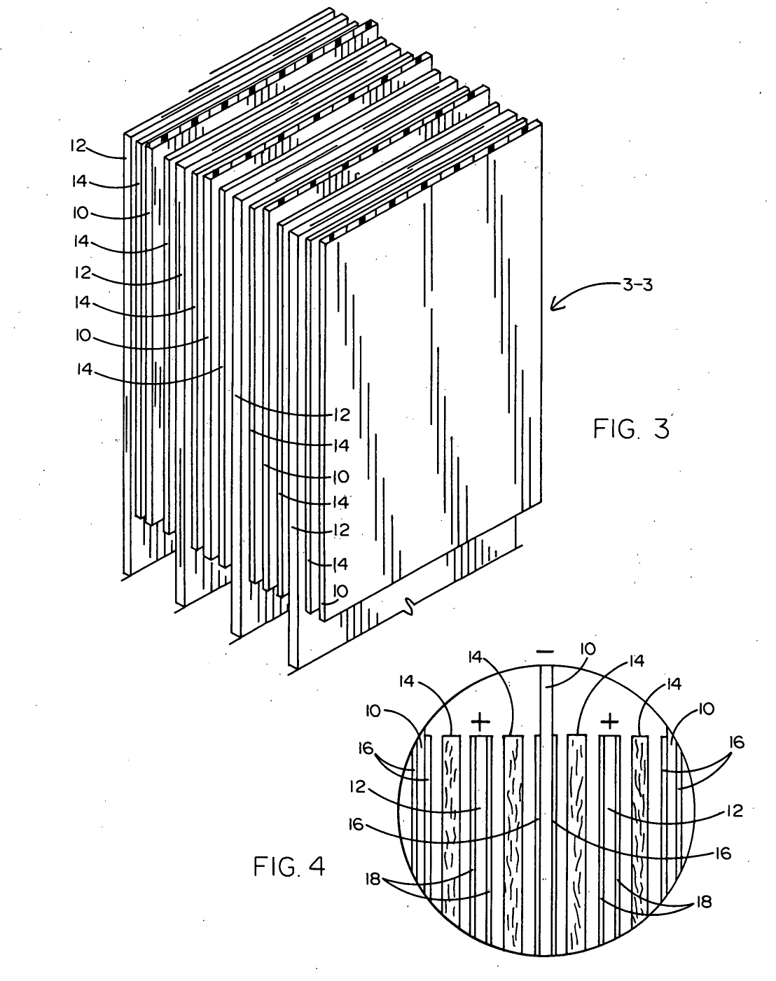

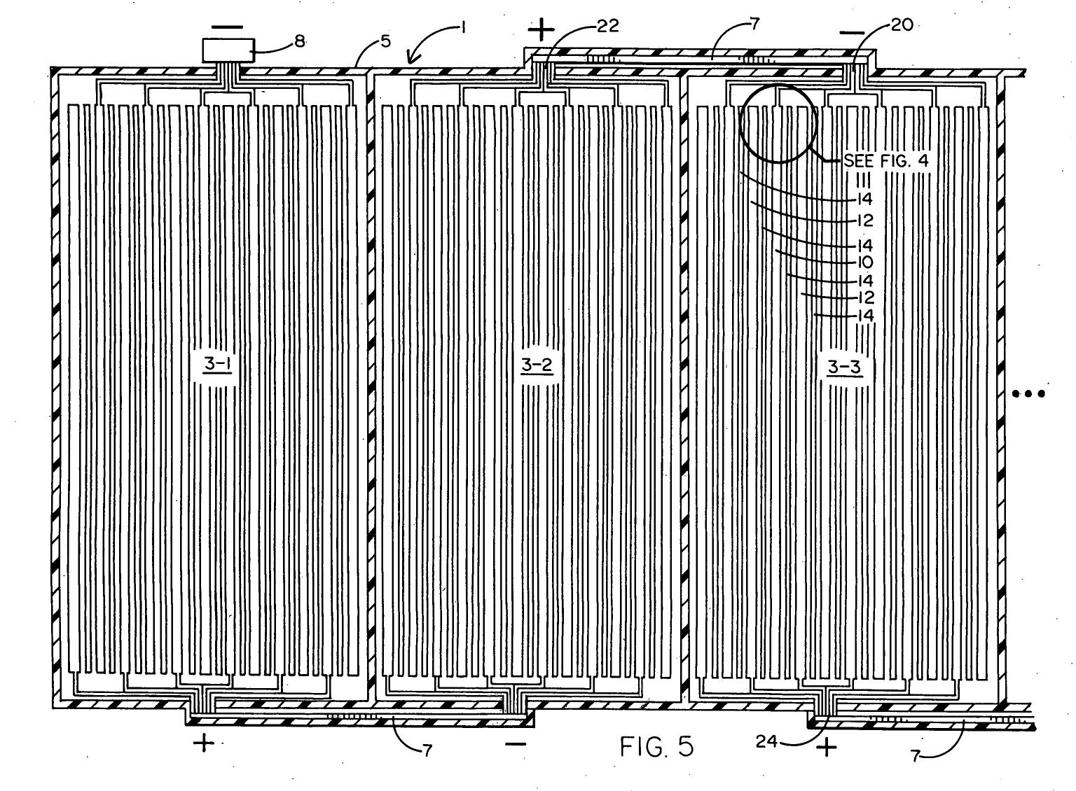

Referring concurrently to FIGS. 2-4 of the drawings, details of one 2-volt cell (e.g., 3-3) from the six battery cells 3-1 . . . 3-6 of the 12-volt lead acid battery 1 of FIGS. 1 and 2 are now described. Each of the other battery cells 3-1, 3-2, 3-4, 3-5 and 3-6 of the battery 1 is identical to the battery cell 3-3. The battery cell 3-3 includes a stack of six planar cathode and six planar anode electrodes 10 and 12 which alternate relative to one another. In order to maximize the volumetric efficiency of the battery, it is important that the cathode and anode electrodes 10 and 12 of each battery cell be flat to achieve minimal spacing therebetween. Therefore, in the case of battery cell 3-3, each of the cathode and anode electrodes 10 and 12 is a thin flat current carrying plate having a large surface area. By way of particular example, each cathode and anode electrode plate 10 and 12 is preferably manufactured from a flexible (e.g., 3-4 mils thick) metal (e.g., lead, lead alloy or nickel) foil substrate that is covered on each side thereof by an electrically-conductive active material. To this end, and as is best shown in FIG. 4, the opposite sides of each cathode electrode plate 10 of cell 3-3 is coated with an active material 16 having a negative charge. The opposite sides of each anode electrode plate 12 are coated with an active material 18 having a positive charge.

Each of the cathode electrode plates 10 of battery cell 3-3 is separated from adjacent anode electrode plates 12 by a spacer 14. The spacers 14 are manufactured from an electrical insulator such as, for example, a glass mat material that is soaked with an electrolyte held in suspension.

By making the cathode and anode electrodes 10 and 12 of the battery 3-3 cell thin metal flexible plates, a relatively large number of plates (e.g., 12) can be stacked face-to-face one another within a relatively small cell volume. Thus, and as will be apparent from FIG. 5, there is little wasted space within each cell 3-1 . . . 3-6 of the battery 1, especially when compared with the voids or wasted spaces that are characteristic of some conventional batteries wherein the cathode and anode electrodes of each cell are thick lead grids that are separated by relatively thick spacers. Hence, the cell-specific energy and the corresponding starting power of the prismatic battery 1 of the present invention are advantageously maximized relative to conventional battery cell configurations.

FIG. 5 shows all twelve of the alternating cathode and anode electrode plates 10 and 12 and the intermediate spacers 14 of the 2-volt battery cell 3-3 closely packed together in a space efficient rectangular cell configuration with little unused space within the cell and between adjacent cells. For convenience of illustration, the negatively and positively charged active materials (designated 16 and 18 in FIG. 4) with which the flexible foil substrates of the cathode and anode electrode plates 10 and 12 are coated have been omitted from FIG. 5.

Terminal ends 20 of the six cathode electrode plates 10 of battery cell 3-3 are crimped together to be electrically connected via a cast-on interconnect 7 to terminal ends 22 of the six anode electrode plates of the preceding battery cell 3-2. Similarly, terminal ends 24 of the six anode electrode plates 12 of battery cell 3-3 are crimped together to be electrically connected via another cast-on interconnect 7 to the terminal ends (not shown in FIG. 5) of the cathode electrode plates of the succeeding battery cell (designated 3-4 in FIG. 2). In this manner, and as is best shown in FIG. 2, successive ones of the space-efficient cells 3-1 . . . 3-6 of the prismatic battery 1 are connected together within the battery casing 5 in electrical series between battery posts 8.

By way of a preferred example, the crimped electrode terminal ends 20 from the battery cell 3-3 and the crimped electrode terminal ends 22 from the adjacent battery cell 3-2 are located in a mold. Molten lead is added to the mold according to a well-known cast-in-place technique to create the cast-on interconnect 7 which bridges the terminal ends 20 and 22 of adjacent battery cells 3-3 and 3-2. The remaining interconnects 7 shown in FIG. 5 are formed in an identical fashion.

It may be appreciated that the cathode and anode electrodes 10 and 12 of the battery 1 are independent rectangular plates that are packed closely together in parallel face-to-face alignment so as to minimize internal resistance. Unlike the use of thick grids wherein electrode plates are pasted together to create a battery cell, the alternating cathode and anode electrode plates 10 and 12 of battery 1 are arranged in a thin stack (best shown in FIG. 5) so as to consume less internal volume of each cell 3-1 . . . 3-6. Hence, the surface contact area between the flat electrode plates 10 and 12 ands the active materials 16 and 18 which cover the plates is increased relative to that associated with conventional grid structured electrode plates. What is more, when the stack of electrode plates are arranged side-by-side one another, there will be little unused or wasted space remaining within the battery casing 5, whereby the volume-efficient prismatic battery 1 is capable of improved stored energy per battery cell.

That is to say, when the rectangular battery cells 3-1 . . . 3-6 are arranged in the side-by-side prismatic formation of FIG. 3, within a typical battery casing (e.g., 5), virtually no gaps are created between successive ones of the cells such that substantially all of the volume within the casing 5 is consumed by current collecting electrodes and active surface material. Thus, it may be additionally appreciated that the prismatic configuration of the rectangular battery cells 3-1 . . . 3-6 of battery 1 enables maximized volumetric efficiency relative to that associated with conventional battery cells resulting in improved high power performance. Therefore, the prismatic battery 1 of FIGS. 1-5 having a standard-sized battery casing 5 will be capable of a cold cranking capacity necessary to start the engines of large motor vehicles even in those situations where the stored energy of the battery has been reduced.

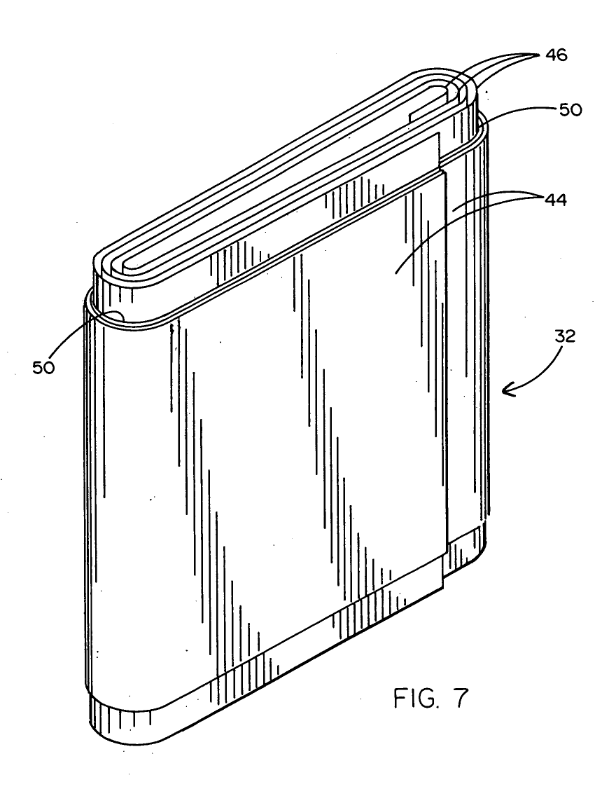

Turning now to FIGS. 6-8 of the drawings, there is shown according to a second preferred embodiment a lead-acid prismatic battery 30 which, like the battery 1 disclosed while referring to FIGS. 1-5, has a generally flat or planar battery cell configuration which enables an increased volumetric efficiency and cranking power when compared with conventional batteries having cylindrical cell configurations. In this regard, the battery 30 includes a total of six cells, only three of which (32-4, 32-5 and 32-6) are visible within a standard battery casing 34. A pair of terminal posts 36 extend upwardly through the top of casing 34 from the first and the last of the battery cells. The six battery cells 32 are connected in electrical series to create a 12-volt prismatic battery 30. Each adjacent pair of cells is separated from one another by a barrier 38 (best shown in FIG. 6) that is manufactured from an electrical insulator (e.g., plastic).

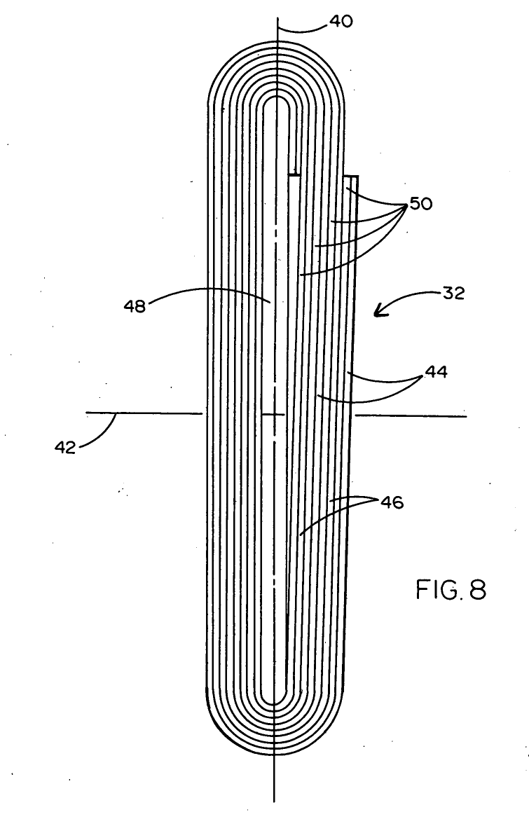

Each of the cells (e.g., 32-4, 32-5 and 32-6) of the battery 30 has an oval configuration. That is to say, and referring specifically to FIG. 8, each battery cell 32 includes a major (i.e., longitudinal) axis 40 and a minor (i.e., lateral) axis 42 that is aligned perpendicular with the major axis 40. The battery cell 32 is longer along its major axis 40 than its minor axis 42. As a result of its oval configuration, each battery cell 32 has a pair of flat faces lying at opposite sides thereof. Thus, and like the rectangular stacks of planar electrode plates from the prismatic battery 1 of FIGS. 1-5, the oval battery cells of the battery 30 are aligned face-to-face one another with spacers 38 located therebetween. With the oval cells 32 packed closely together within the battery casing 34, there will be fewer air gaps between the cells and less unused or wasted space within the casing 34 compared with a battery having a cylindrical cell configuration. Accordingly, the volumetric efficiency of the prismatic battery 30 of FIGS. 6-8 enables the same advantages as those afforded the prismatic battery that was disclosed when referring earlier to FIGS. 1-5.

Each battery cell 32 of prismatic battery 30 includes a flexible cathode electrode plate 44 and a flexible anode electrode plate 46, each of which being preferably manufactured from a thin, electrically-conductive (e.g., a lead, lead alloy or nickel) current carrying metal foil. The cathode and anode electrode plates 44 and 46 are wound prismatically around a solid oval core 48 that is manufactured from an electrical insulator (e.g., plastic). As is best shown in FIG. 7, the windings of the cathode and anode electrode plates 44 and 46 which extend continuously around the oval core 48 of cell 32 alternate so as to lie one inside the other. The precise number of alternating electrode plate windings illustrated in the drawing is for the purpose of example only. However, a large number of windings results in a correspondingly greater stored energy capacity and better performance of the battery 30. In the alternative, the cathode and anode electrode plates 44 and 46 may be continuously wound around a cylindrical mandrel to form a cylindrical battery cell. After removal from the mandrel, the cylindrical cell is flattened to create the oval cell configuration 32 shown in FIGS. 6-8.

As in the case of the electrode plates 10 and 12 of the prismatic battery 1 shown in FIGS. 1-5, the opposite sides of the cathode electrode plate 44 of the battery cell 32 are covered (e.g., coated) with a negatively-charged active material (not shown), and the opposite sides of the anode electrode plate 46 are covered with a positively-charged active material (also not shown). Moreover, an insulating spacer 50 is wound between the alternating plate windings so that the cathode and anode electrode plates 44 and 46 are electrically isolated from one another.

Each of the six oval cells 32 of battery 30 are connected in electrical series within casing 34 by means of relatively wide (e.g., lead) interconnects 54 (best shown in FIG. 6). The interconnects 54 may be created by the same cast-in-place technique that was earlier described. The interconnects 54 function as electrical bridges between successive ones of the oval cells of the battery 30. That is, the interconnects 54 connect the electrode plate winding from one of the battery cells (e.g., 32-5) having a first polarity to the electrode plate winding from an adjacent battery cell (e.g., 32-4) having an opposite polarity. The flexible cathode and anode electrode plates and the corresponding oval (i.e., flat) shape of each battery cell eliminates wasted volume within the battery case resulting in a prismatic battery with maximized volumetric efficiency and improved power performance.

1. A battery including a case and a plurality of prismatic battery cells electrically connected to one another within said case, each prismatic battery cell having a positive and a negative terminal, a stack of alternating cathode and anode electrodes, and a plurality of electrical insulators, wherein each of the cathode and anode electrodes from said stack thereof is a flat electrically-conductive plate and said plurality of electrical insulators are sandwiched between respective pairs of said alternating cathode and anode electric plates.

2. The battery recited in claim 1, wherein each of the flat plates of the alternating cathode and anode electrodes from said stack thereof is manufactured from an electrically-conductive flexible foil covered on opposite sides by one of an electrically-conductive negatively charged or positively charged material.

3. The battery recited in claim 1, wherein the flat cathode and anode electrode plates of said stack thereof are arranged in parallel alignment with respect to one another.

4. The battery recited in claim 1, wherein the flat cathode electrode plates of each prismatic battery cell are electrically connected together at the negative terminal of said battery cell and the flat anode electrode plates of each battery cell are electrically connected together at the positive terminal of said battery cell.

5. The battery recited in claim 4, wherein the positive terminal of a first of said plurality of prismatic battery cells is connected to the negative terminal of a second battery cell and the positive terminal of the second battery cell is connected to the negative terminal of a third battery cell, whereby said first, second and third battery cells are connected to one another in electrical series.

6. The battery recited in claim 5, further comprising a first electrically-conductive interconnect extending between the positive terminal of a first of said plurality of prismatic battery cells and the negative terminal of the second battery cell and a second electrically-conductive interconnect extending between the positive terminal of the second battery cell and the negative terminal of the third battery cell.

7. A battery including a case and a plurality of planar battery cells within said case, each battery cell having perpendicularly-aligned major and minor axes, an electrically-conductive anode electrode, an electrically-conductive cathode electrode, and an electrical insulator sandwiched between said anode and cathode electrodes, said anode and cathode electrodes and said insulator therebetween being wound in an oval configuration, such that said planar battery cell is longer along said major axis thereof than along said minor axis.

8. The battery recited in claim 7, wherein each of said electrically-conductive cathode and anode electrodes is a flexible electrically-conductive metallic foil, the opposite sides of said foil being covered with one of an electrically-conductive negatively charged or positively charged material.

9. The battery recited in claim 7, wherein said anode and cathode electrodes and said insulator therebetween are continuously wound around one another.

10. The battery recited in claim 7, wherein said plurality of planar battery cells are separated from one another by respective barriers manufactured from an electrical insulator material.
